(19) United States
(12) Patent Application Publication
(10) Pub. No.: US 2012/0047322 A1
(43) Pub. Date: Feb. 23, 2012

(54) Method and System of Using One-Time Programmable Memory as Multi-Time Programmable in Code Memory of Processors

(76) Inventor: Shine C. Chung, San Jose, CA (US)

(21) Appl. No.: 13/214,183

(22) Filed: Aug. 20, 2011

Related U.S. Application Data
(60) Provisional application No. 61/375,667, filed on Aug. 20, 2010.

(51) Int. Cl. G06F 12/00

(52) U.S. Cl. 711/103; 711/E12.008

(57) ABSTRACT

A method, device and system of using an One-Time-Programmable (OTP) memory as an Multiple-Time Programming (MTP) memory equivalent is disclosed. The use of OTP memory in this manner allows code to be updated one or more times and yet remain small in size and relatively easy to process (fabricate). The code can be program code for a processor, such as boot code, boot code kernel or other instruction code. According to one aspect, an OTP memory is able to functionally operate as if it were a MTP memory through intelligent use of NOPs, which are no operations. Subsequently, if a particular subroutine or function in the program code needs to be modified, an instruction (e.g., JUMP instruction) can be programmed into the NOP so that certain existing instructions can be bypassed and the execution of instructions of a new module can be performed.

### CROSS-REFERENCE TO RELATED APPLICATIONS

This application claims priority benefit of U.S. Provisional Patent Application No. 61/375,667, filed on Aug. 20, 2010 and entitled “Method and System of Using One-Time Programmable Memory as Multi-Time Programmable in Code Memory of Microprocessors,” which is hereby incorporated herein by reference.

### BACKGROUND OF THE INVENTION

### Description of the Related Art

A microprocessor makes use of code memory and data memory to store instructions and temporary data, respectively. The codes, or instructions, stored in the code memory are fetched, decoded, and executed on data from scratch-pad registers or from temporary data memory, such as cache or main memory, and then store them back into registers, caches, or main memory. In a general electronic system (e.g., computer), the whole code memory is normally stored in a non-volatile memory such as hard disk drive or solid state flash drive. A subset of code memory, such as main memory or instruction cache, are built in volatile memories such as DRAMs, SRAMs, or even integrated with the microprocessor. For most embedded systems, the code memory tends to have small size and can be implemented in flash memory embedded with its Micro-Controller Unit (MCU) to reduce cost.

FIG. 1 shows a block diagram of an MCU 20 having a code memory 21, data memory 22, execution unit 24, and I/O peripheral 23. The code memory 21 is a flash memory in a conventional MCU to store instructions for execution. Data memory 22 is an SRAM to store temporary data, which could be a subset of a larger capacity DRAM external to the MCU chip 20. The execution unit 24 is usually an ALU or equivalent to do arithmetic and logic operations. I/O peripherals 23, such as timers, I/O ports, GPIO, ADC, DAC, etc, interface the MCU 20 with external I/O devices. Today, for an 8-bit MCU, the code memory 21 has a size up to 64 KB, and the data memory 22 has a size up to 64 KB. The sizes of code and data memories tend to be larger for 16-bit or even 32-bit MCUs.

For System-on-Chips (SoCs), there are always embedded processors built in to do complicated tasks, rather than depending on hard-wired random logic. For high-end SoCs, the code memory is very large that tends to be stored in an external flash memory, but the boot ROM, or kernel of the boot ROM, is built in the SoCs to jump start the embedded processor. The kernel or boot ROM is very crucial to an SoC, because if the kernel or boot ROM has bugs, the SoC will not be started.

FIG. 2 shows a block diagram of an SoC 30 with an external boot ROM 33. The SoC 30 has an embedded processor 31, and a kernel of boot ROM 32. The embedded processor 31 can be a 32-bit or 64-bit processor, or a Digital Signal Processor (DSP) that uses a kernel of boot ROM 32 to bootstrap starting the processor 31. The kernel of the boot ROM 32 provides the initial instructions to start the embedded processor 31. Then, more instructions in the external Boot ROM 33 are loaded to finish processor initialization and start normal operations. For a typical SoC that has a 32-bit processor, the external boot ROM size can be about 1-2 MB. The kernel size can be easily in the range of 16 KB. The kernel is preferably built in Programmable ROM (PROM), especially field programmable ROM, so that the boot code can be modified after fabrication.

The ideal kernel of boot ROM in an SoC is probably an embedded flash or Multiple-Time-Programmable (MTP) memory so that the boot code can be modified several times in most applications. Flash memory can usually be programmed about 20,000 times, but flash memory tends to be two to three generations behind the advanced CMOS process and requires about 7-8 most masks to fabricate, which makes it too expensive. MTP memory can be built in the same logic process with a few added masks, but the cell size is very large, about ten times (10×) larger than an SRAM cell in the same technology, which makes MTP memory impractical from being used for boot code kernels. One-Time-Programmable (OTP) memory has small size, simple process, low cost, but the memory cell can only be programmed once, which is not sufficient to serve as code memory or kernel of a boot ROM.

Accordingly, there is a need for improved designs for boot code kernels, boot code or code memory for storage of instructions executed by a processor which facilitates fast time to market, robust design, and reduced costs as compared to conventional flash or MTP for boot code kernel, boot code, or even code memory.

### SUMMARY OF THE INVENTION

The invention pertains to a method, device and system of using an One-Time-Programmable (OTP) memory as an Multiple-Time Programming (MTP) memory equivalent to allow code to be updated one or more times and yet remain small in size and relatively easy to process (fabricate). The code can be program code for a processor, such as boot code, boot code kernel or other instruction code. For example, the OTP memory can be fabricated with standard CMOS processes as memory to replace the costly FLASH memory or Multiple-Time-Programmable (MTP) memory for processors, such as microprocessors, Micro-Controller Unit (MCU), embedded processors, or Digital Signal Processors (DSP).

According to one aspect, an OTP memory is able to functionally operate as if it were a MTP memory through intelligent use of NOPs, which are no operations. During normal operations, the NOPs are executed but nothing happens, except wasting a few clock or processing cycles. The processor's NOP code needs to be coincident with an instruction word of OTP's virgin state, i.e., NOP has all 0s and 0 is the virgin state of OTPs.

In one embodiment, program code is stored in the OTP memory. The program code is made modular with many subroutines or functions under a main program so that each module can be patched. One or more NOPs can be inserted in the beginning of those subroutines or functions in the program code that might be changed. Then, if a particular subroutine or function in the program code needs to be modified, an instruction (e.g., JUMP instruction) can be programmed into the NOP so that certain existing instructions can be bypassed and the execution of instructions of a new module can be performed. The new module can also be programmed into an unused space a memory map. Similarly, a block of code can be inserted by programming such into a new subroutine and programming a NOP instruction to call this subroutine. A block of code can be deleted by programming a JUMP instruction with a suitable target address into a NOP space so that a block of instructions following that NOP can be bypassed.

The invention can be implemented in numerous ways, including as a method, system, device, apparatus (including computer readable medium and graphical user interface). Several embodiments of the invention are discussed below.

As an integrated circuit, one embodiment can, for example, include: a processor; a One-Time-Programmable (OTP) memory as a part or all of a memory operatively coupled to the processor; and an instruction code for the processor. The instruction code can be programmed into the OTP memory, and the instruction code can have a plural of modules and at least one of the modules can have at least one No-Operation (NOP) instruction. The at least one module can having at least one NOP instruction being configured to be updated by programming a new module into an unused portion of the OTP memory and by programming a module-calling or branch instruction into the at least one NOP instruction to jump to a starting address of the new module or to a new target address upon execution.

As an electronics system, one embodiment can, for example, include: a processor; a One-Time-Programmable (OTP) memory as a part or all of a code memory operatively coupled to the processor; and an instruction code for the processor.

The instruction code can be programmed into the OTP memory, and the instruction code can have a plural of modules and at least one of the modules can have at least one No-Operation (NOP) instruction. The at least one module can having at least one NOP instruction being configured to be updated by programming a new module into an unused portion of the OTP memory and by programming a module-calling or branch instruction into the at least one NOP instruction to jump to a starting address of the new module or to a new target address upon execution.

As a method of providing an OTP memory configured to be updateable, one embodiment can, for example, include at least: storing instruction code into the OTP memory, the instruction code to be executed by a processor operatively connect to the OTP memory, the instruction code having a plural of modules, and at least one of the modules having at least one No-Operation (NOP) instruction at a NOP location; subsequently programming a new module into a previously unused portion of the OTP memory to stored additional instruction code to the OTP memory; and programming a module-calling or branch instruction into the NOP location to subsequently direct program execution to the additional instruction code of the new module.

As a non-transitory computer readable medium including at least computer program code stored thereon for programming an OTP memory configured to be updateable, one embodiment can, for example, include: computer program code for storing instruction code into the OTP memory, the instruction code stored being to be executable by a processor operatively connect to the OTP memory, the instruction code having a plural of modules, and at least one of the modules having at least one No-Operation (NOP) instruction at a NOP location; computer program code for subsequently programming a new module into a previously unused portion of the OTP memory to stored additional instruction code to the OTP memory; and computer program code for programming an instruction into the NOP location to subsequently redirect program execution to the additional instruction code of the new module.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The present invention will be readily understood by the following detailed descriptions in conjunction with the accompanying drawings, wherein like reference numerals designate like structural elements, and in which:

FIG. 1 shows a block diagram of an MCU having a code memory).

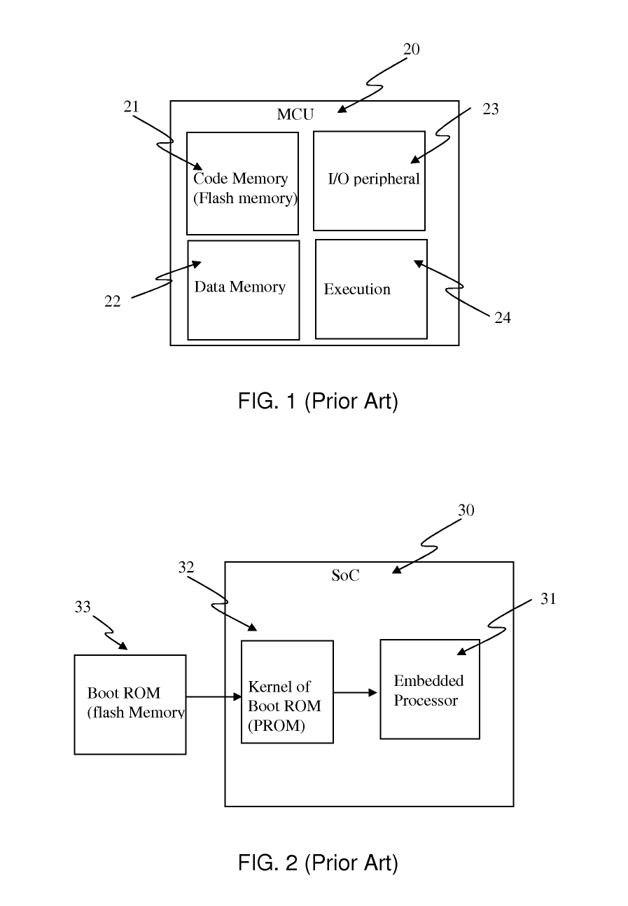

FIG. 2 shows a block diagram of an SoC having a kernel of boot ROM.

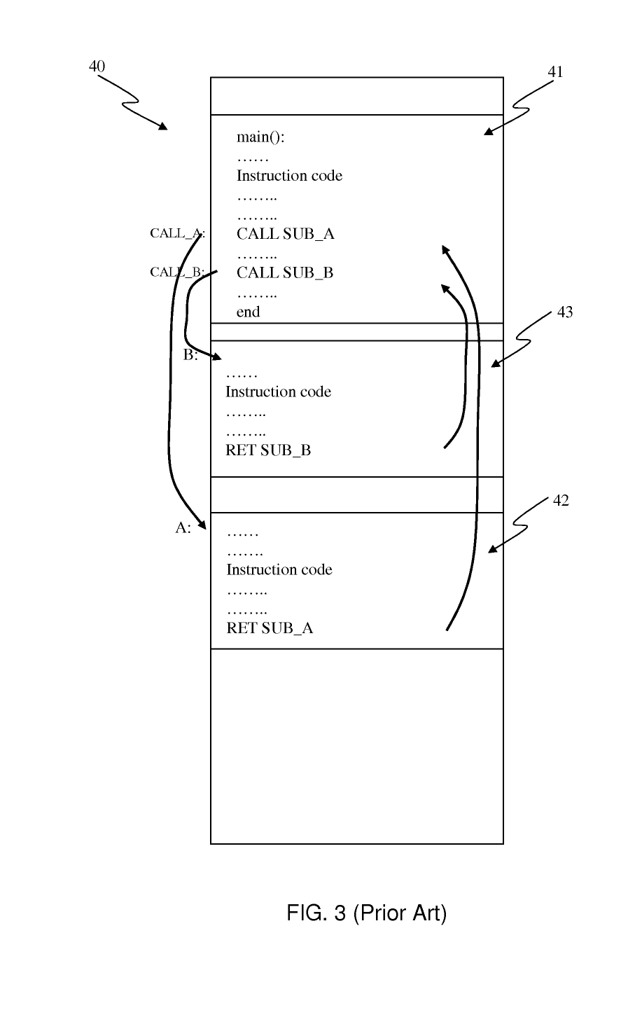

FIG. 3 shows executing a program in a memory map.

FIG. 4(a) shows modifying codes for an OTP used as MTP equivalent in accordance with one embodiment.

FIG. 4(b) shows inserting codes for an OTP used as MTP equivalent in accordance with one embodiment.

FIG. 4(c) shows deleting codes for an OTP used as MTP equivalent in accordance with one embodiment.

FIG. 5 shows modifying codes multiple times for an OTP used as MTP equivalent in accordance with one embodiment.

FIG. 6(a) shows one embodiment of a method to prepare a program for an OTP to be used as MTP equivalent in accordance with the present invention. FIG. 6(b) shows another embodiment of a method to prepare a program for an OTP to be used as MTP equivalent in accordance one embodiment.

FIG. 7(a) shows a method to modify codes for an OTP to be used as MTP equivalent in accordance with one embodiment.

FIG. 7(b) shows a method to insert codes for an OTP to be used as MTP equivalent in accordance with one embodiment.

FIG. 7(c) shows a method to delete codes for an OTP to be used as MTP equivalent in accordance with one embodiment.

FIG. 8 shows a block diagram of a portion of a One-Time Programmable (OTP) memory according to one embodiment.

FIG. 9 shows a block diagram of a simplified electronic system having a processor with an OTP memory that contains a portion of initially programmed code and initially unprogrammed code to function as an MTP according to one embodiment.

### DETAILED DESCRIPTION OF EMBODIMENTS OF THE INVENTION

The invention pertains to a method, device and system of using an One-Time-Programmable (OTP) memory as an Multiple-Time Programming (MTP) memory equivalent to allow code to be updated one or more times and yet remain small in size and relatively easy to process (fabricate). The code can be program code for a processor, such as boot code, boot code kernel or other instruction code. For example, the OTP memory can be fabricated with standard CMOS processes as memory to replace the costly FLASH memory or Multiple-Time-Programmable (MTP) memory for processors, such as microprocessors, Micro-Controller Unit (MCU), embedded processors, or Digital Signal Processors (DSP).

According to one aspect, an OTP memory is able to functionally operate as if it were a MTP memory through intelligent use of NOPs, which are no operations. During normal operations, the NOPs are executed but nothing happens, except wasting a few clock or processing cycles. The processor's NOP code needs to be coincident with an instruction word of OTP's virgin state, i.e., NOP has all 0s and 0 is the virgin state of OTPs.

In one embodiment, program code is stored in the OTP memory. The program code is made modular with many subroutines or functions under a main program so that each module can be patched. One or more NOPs can be inserted in the beginning of those subroutines or functions in the program code that might be changed. Then, if a particular subroutine or function in the program code needs to be modified, an instruction (e.g., JUMP instruction) can be programmed into the NOP so that certain existing instructions can be bypassed and the execution of instructions of a new module can be performed. The new module can also be programmed into an unused space a memory map. Similarly, a block of code can be inserted by programming such into a new subroutine and programming a NOP instruction to call this subroutine. A block of code can be deleted by programming a JUMP instruction with a suitable target address into a NOP space so that a block of instructions following that NOP can be bypassed.

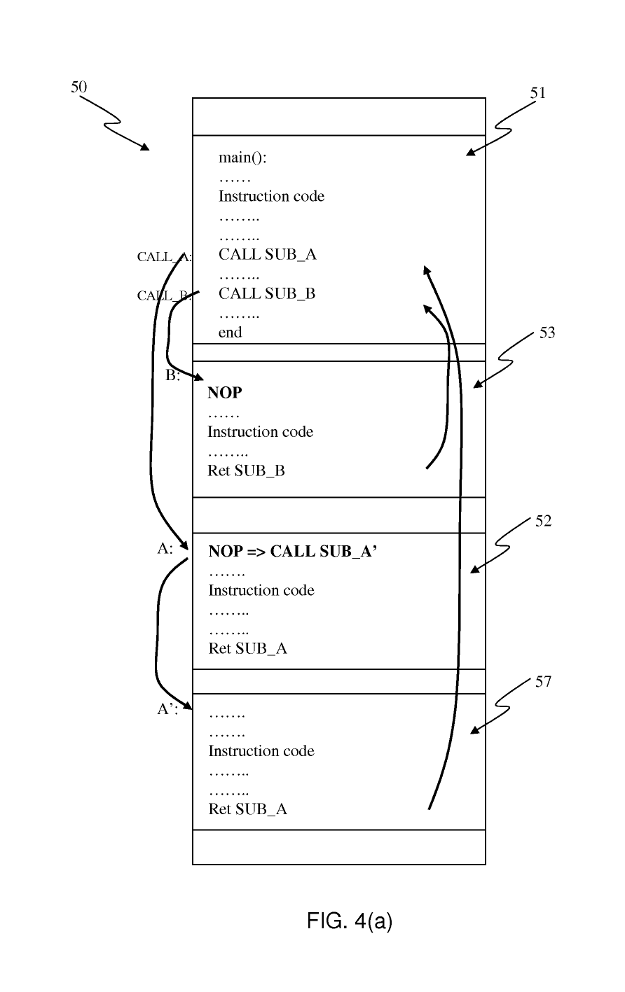

FIG. 3 shows an exemplary conventional execution of a program 40 in a memory map. The program 40 starts with a main module 41 with a starting address and an end address. Inside the main module 41 are many modules of subroutines or function calls. The instructions, except branches or jumps, are executed from low to high order along the memory map. When an instruction encounters a subroutine or function, the next instruction will jump to the starting address of the subroutine or function. Essentially, the CALL SUB_A instruction behaves like “JUMP M[A]”, where A is the starting address of the module SUB_A, which is module 42 in FIG. 3. The instructions are continuously executed along the subroutine SUB_A until a RET SUB_A is encountered. The RET SUB_A instruction is another form of branch instruction to branch back to the next instruction following CALL SUB_A instruction. If the CALL SUB_A instruction is on the memory address CALL_A, the return to SUB_A will be JUMP M[CALL_SUB_A]+1, if the instruction size is 8-bit. In today's computer technologies, memory map is based on byte address, i.e. one address points to one byte only. If an instruction has 32 bits, like today's most embedded processors, general purpose microprocessors, or DSPs, the instruction next to an instruction at A is actually located at A+32/8, or A+4. In general, calling a subroutine and returning from a subroutine involves saving and restoring architecture states, other than just jump functions. If another CALL SUB_B is encountered, the program execution will jump to module SUB_B which is module 43 in FIG. 3, continue executing in SUB_B, and jump back to the next instruction following the calling instruction after reaching the end of SUB_B. The same procedure goes on and on until an “end” instruction is met in main module 41 which stops the execution. The subroutine or function calls can also be nested many times in a program.

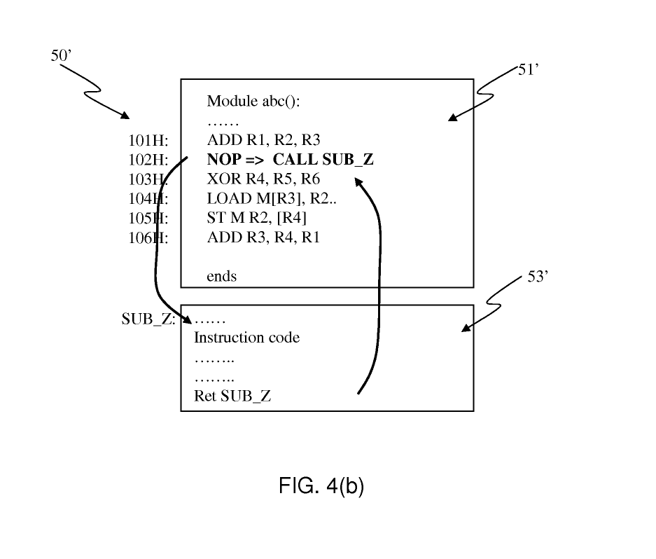

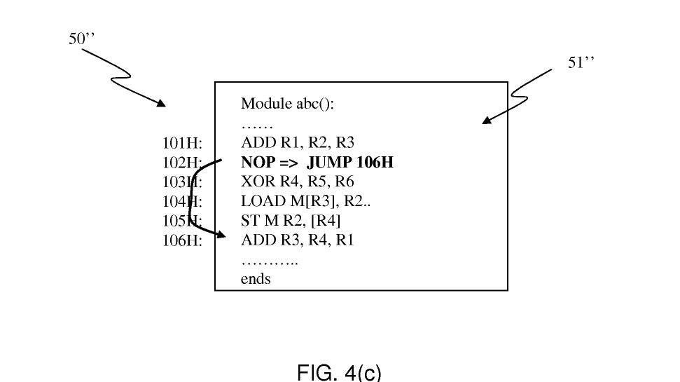

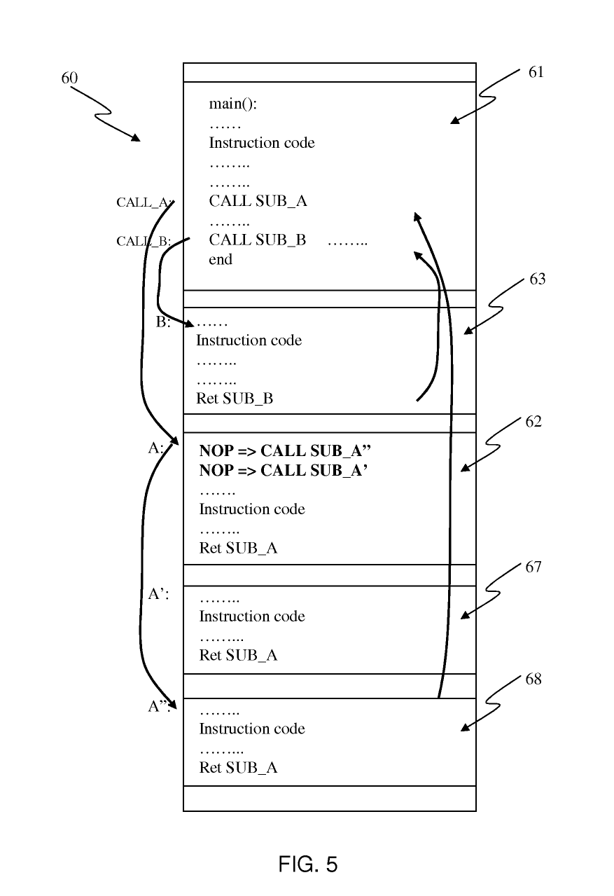

FIG. 4(a) shows a program 50 having modified codes in an OTP memory according to one embodiment. The program 50 is provided as an MTP equivalent in code memory in accordance with one embodiment. The program 50 has a main module 51 with two subroutine calls SUB_A and SUB_B in a memory map as shown in FIG. 4(a). To prepare for future code modification, a NOP can be inserted at a starting address of subroutine module A 52. Essentially, an NOP is executed first when calling the subroutine module 52 via subroutine call SUB_A. Executing a NOP changes nothing except wasting one cycle in execution. When a bug is found in subroutine module A 52, a new subroutine module A′ 57 can be programmed in a blank space in the same OTP memory and the NOP instruction in the beginning of the subroutine module A 52 can be programmed into “CALL SUB_A′”. By using this method, the subroutine module A 52 that has bugs can be bypassed without having to erase and re-program the code memory as would be required with conventional MTP. The same approach can also be applied to subroutine module B 53.

To make this method effective, an instruction word of an OTP's virgin state needs to be coincident with the NOP code in a microprocessor (or processor). In most microprocessors, the NOP code is a word of all 0s. As long as the virgin state of an OTP is set as 0, this method can work satisfactorily. The above description is for illustrative purpose. Those skilled in the art understand that the same bypass scheme can be applied to one or more instruction groups, modules, subroutines or functions, and they can be nested.

FIG. 4(b) shows one embodiment of inserting codes in a program 50′ in an OTP memory operating as MTP equivalent in accordance with one embodiment. The program 50′ is built in a memory map having a module abc 51′. A NOP instruction has been inserted in at memory address 102H, where H refers to hexadecimal. This NOP instruction allows a block of instructions to be inserted between 101H and 103H by programming a new instruction “CALL SUBZ” into 102H and programming a block of instructions in a subroutine SUB_Z 53′ into a blank space of the OTP. When executing the instruction “CALL SUB_Z” at 102H, the execution flow will jump to the start address of the newly created subroutine SUB_Z 53′ and continue execution, and then on completion of the subroutine SUB_Z 53′ the execution flow can return to 103H. In effect, a block of instructions in SUB_Z 53′ is inserted between 101H and 103H. The above description is for illustrative purposes only. Those skilled in the art understand that the NOPs can be inserted in any memory addresses such as main program, subroutine, or functions in any numbers to insert one or more instructions after re-program, and the subroutine or functions may be nested.

FIG. 4(c) shows one embodiment of deleting codes in a program 50″ in an OTP memory operating as MTP equivalent in accordance with one embodiment. The program 50″ is built in a memory map having a module abc 51″. A NOP instruction has been inserted in at memory address 102H. This NOP instruction allows a block of instructions to be deleted between 101H and 105H by programming a “JUMP 106H” into 102H. With the instruction “JUMP 106H” replacing a NOP, the program execution at 102H will jump to 106H and bypass instructions between 102H and 106H. In essence, a block of instructions between 102H and 106H are effectively deleted, or bypassed. The target address in the JUMP instruction for most microprocessors can be an absolute memory address, relative memory address, or a memory address in a register with an offset. If only a few instructions are deleted or bypassed, a jump instruction referring to the current address with an offset can be achieved in one NOP space; otherwise, more than one NOPs may be needed to build the target address. The above description is for illustrative purposes only. Those skilled in the art understand that the NOPs can be inserted in any memory addresses such as main program, subroutine, or functions in any numbers to delete one or more instructions after re-program, and the subroutine or functions may be nested.

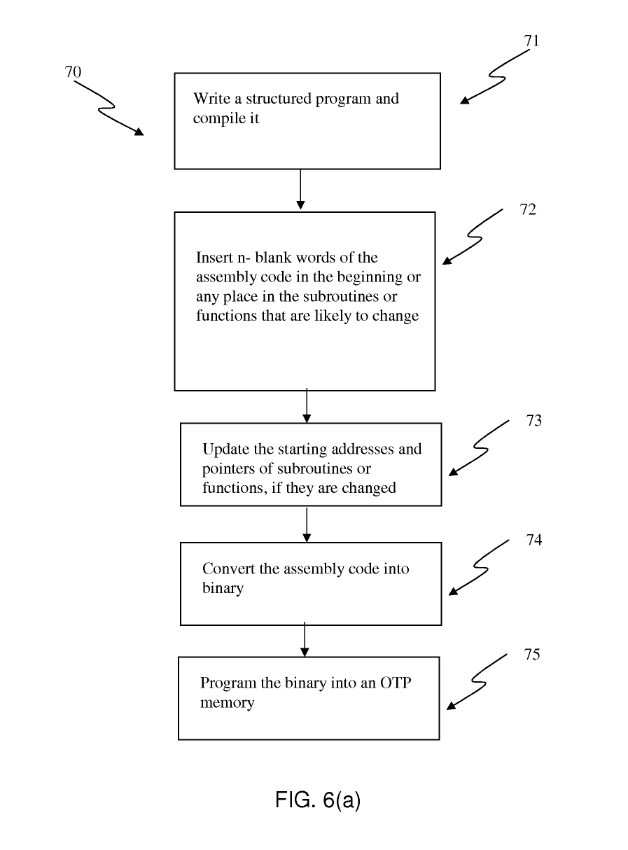

FIG. 5 shows another embodiment of modifying codes multiple times in a program 50 in an OTP memory operating in accordance with one embodiment. The program 60 has a main module 61 having two subroutine calls SUB_A and SUB_B, subroutine module A 62 and subroutine B 63 in a memory map. To prepare for future code modification, two words of NOP can be inserted at the starting address of the subroutine module A 62. The two NOPs are executed first when calling the subroutine module A 62. Executing NOPs changes nothing except wasting two cycles in execution. When a bug is found in subroutine module A 62, a new subroutine module A′ 67 can be programmed in a blank space in the same OTP and the second NOP instruction in the beginning of subroutine module A can be programmed as “CALL SUB_A′”. By using this method, the subroutine module A 62 that has bugs can be by-passed without erasing and re-programming the code memory as in the conventional MTP. If there are more bugs later found in the new subroutine module A′, a newer subroutine module A″ can be programmed into another blank space of the same OTP and the first NOP in the subroutine module A can be re-programmed as “CALL SUB_A″”. In such case, the previous subroutine modules A and A′ can be bypassed. The same scheme can be applied to subroutine module B 63 as well. In general, n entries of NOPs put in the beginning of a module allows that module be modified n times, which is equivalent to an n-time MTP. The scheme also works for inserting a block of code n times or deleting a block of code n times by pre-building n NOPs at one memory location. Programming the NOP instructions always start with the latest NOP in the memory map. To make this method work, an instruction word of the OTP's virgin state needs to be coincident with the NOP code in a microprocessor. In most microprocessors, the NOP code is a word of all 0s. As long as the virgin state of an OTP is set as 0, this scheme can work satisfactorily. The above description is for illustrative purpose. Those skilled in the art understand that the same by-pass scheme can be applied to one or more instruction groups, modules, subroutines or functions, and the modules can be nested.

Alternatively, more than one modification can be made to a program by providing one or more NOPs in any new modules programmed into the OTP. The new modules can then be further modified through programming of the one or more NOPs.

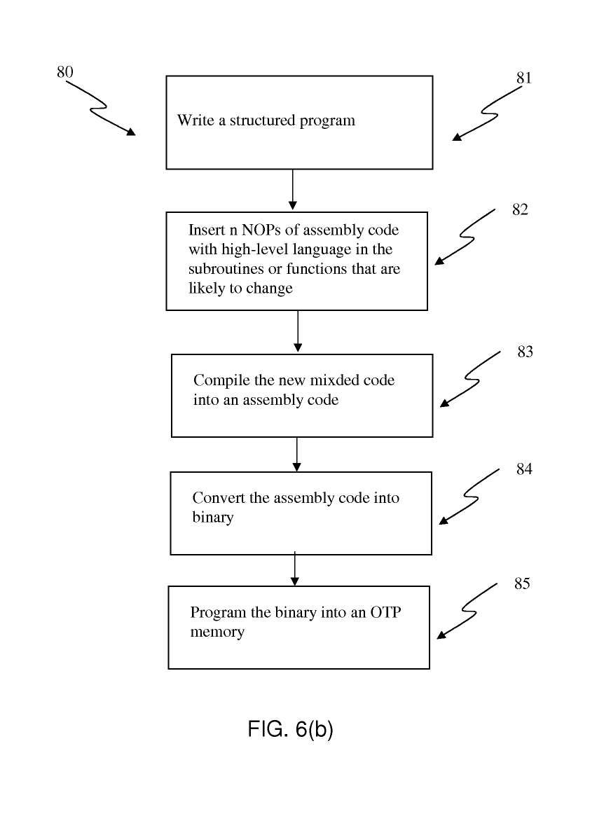

FIG. 6(a) shows one embodiment of a method 70 for preparing a program so that an OTP memory can be used as an MTP equivalent in according with one embodiment. The first step 71 is to write a structured program, which is a program that contains modules with many subroutines or functions. The structured programming can be modified with relative ease if there are any updates. The subroutines or functions can also be nested in many levels. After a program is prepared, the program can be compiled into assembly language in step 71. The second step 72 can insert n blank words, or NOPs, in the beginning or any place of those subroutines or functions that are likely to be modified. For example, of an initial memory address is A, then NOPs can be inserted at memory address A, A+1, . . . , A+(n−1). The “n” blank words allow that subroutine or function to be modified, for example by effectively inserting or deleting codes of the program up to n-times in the same OTP memory. The third step 73 is to update pointers of the subroutines or functions that are amended with the inserted NOPs. The starting addresses of the subroutines or functions could be shifted in the memory map after inserting NOPs. Hence, the target addresses of the calling instructions are likewise shifted. The fourth step 74 is to convert the resulting assembly code into binary. The last step 75 is to program the binary into an OTP memory. The above description is for illustrative purpose. Those skilled in the art understand that the number of NOPs can be arbitrary and can be put in any place in some or all of the subroutines or functions, depending on the needs.

FIG. 6(b) shows a method 80 for preparing a program so that an OTP memory can be used as MTP equivalent in accordance with another embodiment. The first step 81 is to write a structured program, which is a program that contains modules with many subroutines or functions. The second step 82 is to insert n NOPs of assembly code into the beginning or any place of the subroutines or functions that are likely to be modified. Inserting assembly codes into the program written in high-level language is called “in-lining.” The third step 83 is to compile the mixed high-level language with assembly code into a full assembly code. The fourth step 84 is to convert the assembly code into binary. The last step 85 is to program the binary into an OTP memory. The above description is for illustrative purpose. Those skilled in the art understand that the number of NOPs can be arbitrary and can be put in any place in some or all of the subroutines or functions, depending on the needs.

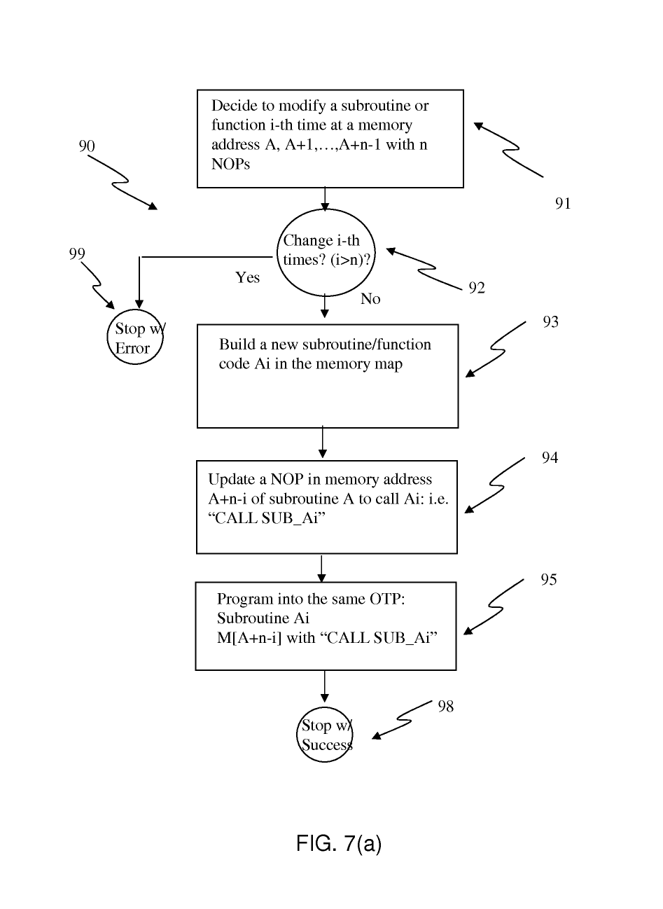

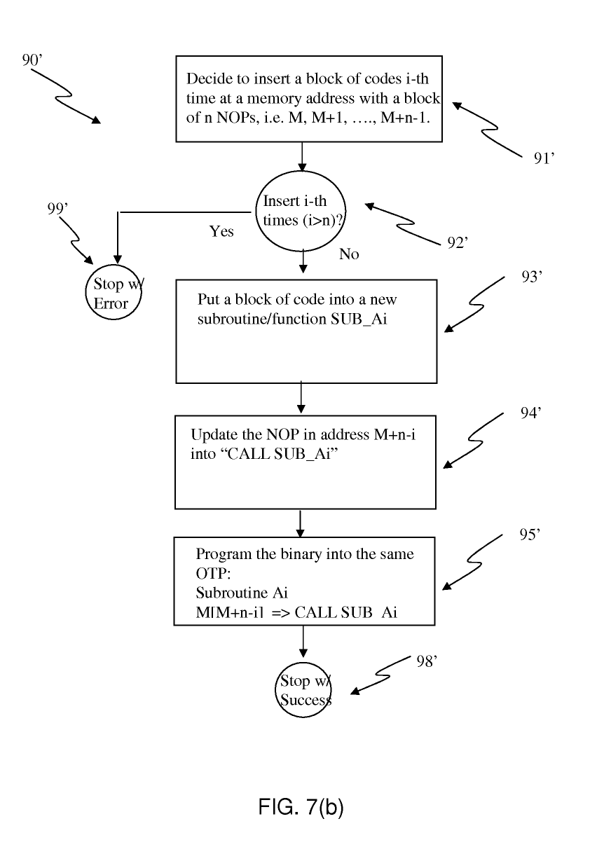

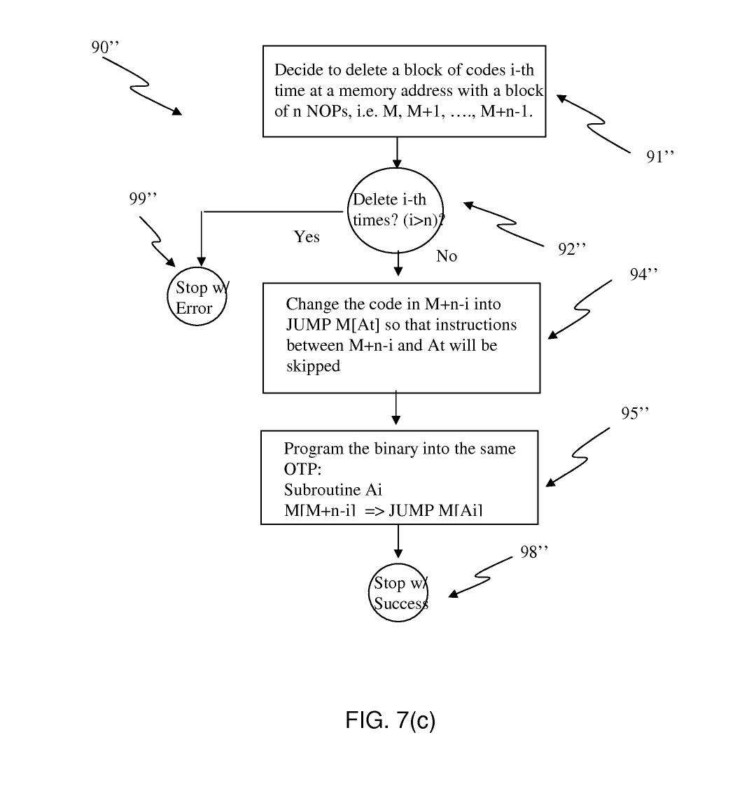

FIG. 7(a) shows one embodiment of a method 90 updating an OTP memory when a portion of code stored therein needs to be modified. In the first step 91, determine which subroutine or function to modify. As an example, subroutine A will be modified for the i-th time, n>=i>0. The second step 92 determines if the number of modifications exceed an allowable limit, i.e. determine if i is larger than n. If yes, stop the method 90 with an error at state 99. In this case, the OTP memory cannot be further modified. If not, proceed to the third step 93 where new subroutine code Ai can be built into a spare memory space in the OTP memory. Then, in the fourth step 94 the subroutine A is changed to program a calling instruction to point to the new subroutine Ai. This call instruction can be inserted into the subroutine A by modifying the (n−i)-th entry of subroutine A to point to Ai, i.e. change the NOP in M[A+n−i] to “CALL SUB_Ai”. In other words, re-programming NOPs should in most cases start with the latest available NOPs in execution order. In the last step 95, new code for the subroutine Ai is programmed into the same OTP memory. After step 95, the code in the OTP memory has been successfully modified and the method 90 can stop at state 98. The above description is for illustrative purpose, those skilled in the art understand that the number of NOPs can vary, the number of subroutines or functions can vary, and the subroutines or functions can be nested.

FIG. 7(b) shows one embodiment of a method 90′ updating an OTP memory when a portion of code needs to be inserted. In the first step 91′, determine which block of code to be inserted into a memory address having n NOPs at M, M+1, M+2, . . . , M+n−1. Inserting starts with programming NOPs in the address M+n−1, M+n−2, . . . , till M. The second step 92′ determines if the number of insertion exceeds the allowable limits, i.e. determine if i is larger than n. If yes, stop the method 90 with an error at state 99′. In this case, the OTP memory cannot be further modified. If not, proceed to the third step 93′ where a block of new code can be programmed into new subroutine code SUB_Ai in a spare memory space in the OTP memory. Then, in the fourth step 94′ the NOP in the address M+n−i can be changed to CALL SUB_Ai. In other words, re-programming NOPs should in most cases start with the latest available NOPs in execution order. In the last step 95′, the new added code can be programmed into the same OTP. After step 95′, the code in the OTP memory has been successfully modified and the method 90′ can stop at state 98′. The above description is for illustrative purpose, those skilled in the art understand that the number of NOPs can vary, the number of subroutines or functions can vary, and the subroutines or functions can be nested.

FIG. 7(c) shows one embodiment of a method 90″ updating an OTP memory when a portion of code needs to be deleted. In the first step 91″, determine which block of code to be deleted near a memory address having n NOPs at M, M+1, M+2, . . . , M+n−1. Deleting starts with programming NOPs in the address M+n−1, M+n−2, . . . , till M. The second step 92″ determines if the number of deletion exceeds the allowable limits, i.e. determine if i is larger than n. If yes, stop the method 90″ with an error at state 99″. In this case, the OTP memory cannot be further modified. If not, proceed to the third step 94″ to change the latest NOP in the address M+n−i can be changed to “JUMP At”, where At is the target address. All instructions between memory address M+n−i and At will be effectively deleted or, more precisely, bypassed. Re-programming NOPs should in most cases start with the latest available NOPs in execution order. In the last step 95″, the new added code is programmed into the same OTP memory. After step 95″, the code in the OTP memory has been successfully modified and the method 90″ can stop at state 98″. The above description is for illustrative purpose, those skilled in the art understand that the number of NOPs can vary, the number of subroutines or functions can vary, and the subroutines or functions can be nested, and that are still within the scope of this invention.

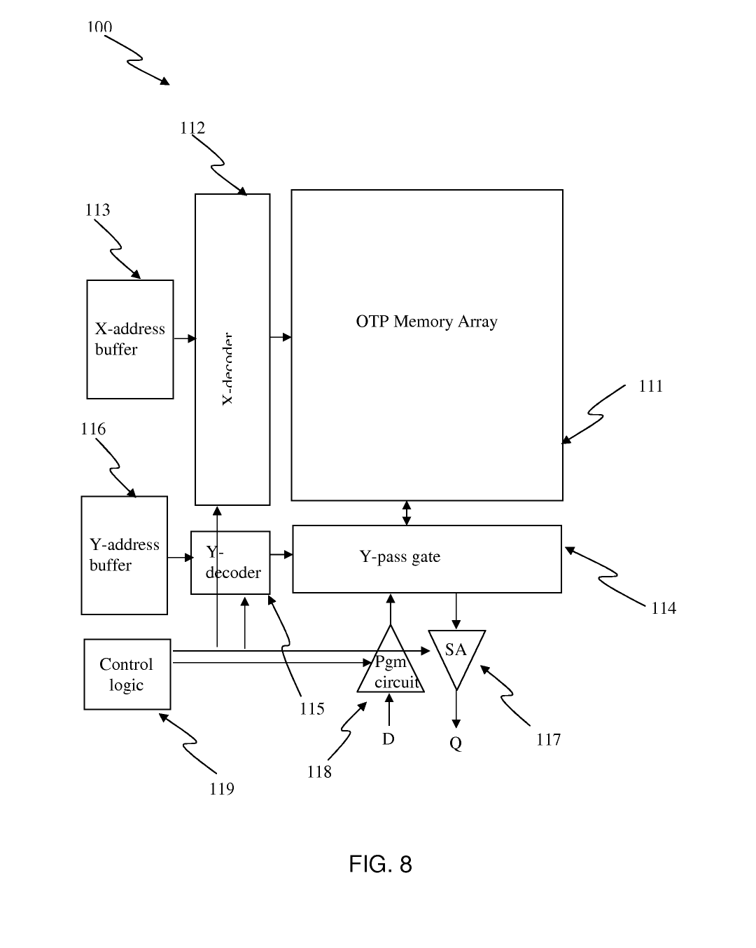

FIG. 8 shows a block diagram of a portion of a One-Time Programmable (OTP) memory 110. The OTP memory 110 provides data storage but it can only be programmed (written) once. The OTP memory has at least one OTP memory array 111, X-decoders 112, X-address buffers 113, Y-pass gates 114, Y-decoders 115, Y-address buffers 116, sense amplifiers 117, program circuit 118, and control logic 119. The OTP memory array 111 can be organized as a two-dimensional array with X- and Y-selects. The OTP memory array 111 includes a plurality of memory cells. The memory cells, although OTP memory cells, can be programmed or configured to support re-programming through program modification as discussed in the various embodiments above. For example, initial programming to the OTP memory array 111 can include NOPs which can be later altered (i.e., programmed) to modify programming and thus program execution of code programmed into the OTP memory array. For example, program modification can be achieved by branching or jumping to a different program location which can be new code or existing code.

To select a row for program or read, select proper X-address signals to travel from X-address buffers 113, through X-decoders 112 to turn on a row. To select a column for program or read, select proper Y-address signals to travel from Y-address buffers 116, through Y-decoders 115 to turn on Y-pass gates 114. To read at least one memory cell, cell data goes through Y-pass gates 114, sense amplifiers 117 with buffers, if necessary, to an output signal Q. To program at least one cell memory, input data D go through a program circuit 118, Y-pass gates 114, to the OTP memory cells. The control logic 119 is responsible to generate suitable signals to turn on X/Y-decoders, row/columns, program circuits or sense amplifiers. For a larger OTP memory, X- or Y-predecoders may be needed. There may be high voltage involved in programming an OTP memory. Therefore, the control logic 119 may be responsible to trigger charge pump circuits and there may be high voltage circuits in the X-decoders 112, Y-decoders 115, or program circuits 118.

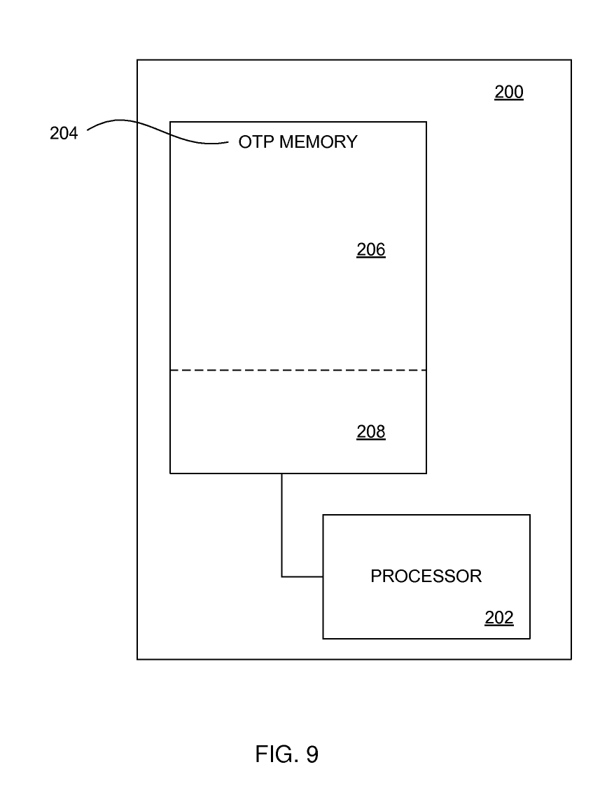

FIG. 9 shows a block diagram of a simplified electronic system 200 according to one embodiment. The electronic system 200 can represent a circuit substrate (e.g., printed circuit board, flex circuit), an integrated circuit (e.g., microprocessor, system on a chip, ASIC, graphics controller, micro-controller) and the like. The electronic system 200 can also be implemented as at least a portion of an electronic product, such as a computer (personal computer, desktop computer, tablet computer, notebook computer, handheld computer), electrical appliance, and various other consumer electronic devices (e.g., mobile phone).

The electronic system 200 can include a processor 202 and an OTP memory 204. The OTP memory 204 stores code (or instructions) that can be executed by the processor 202. The code can be for any purpose, include boot code, utility code, operating system code, device drivers, etc. As shown in FIG. 9, the OTP memory 204 can include an initially programmed section 206 and an initially un-programmed section 208. According to embodiment of the invention discussed above, the initial code that resides in the initially programmed section 206 can be modified (e.g., fixed, repaired, supplemented, changed or altered) by initially provided non-operations (NOPs) in the initial code within the initially programmed section 206. These NOPs are provided and executed but do nothing. In implementation, the NOPs in the initially programmed section 206 are formed in the native state of the OTP memory cells and thus are not programmed. Hence, even though the memory cells are on-time programmable, these particular cells are not initially programmed and therefore can be later programmed. Initially, the initially un-programmed section 208 is empty or not programmed.

Hence, at some time later, it can be learned that the initial code stored in the initially programmed section 206 of the OTP memory 204 and being executed by the processor 202 at appropriates times requires modification for whatever reason. In such case, one or more of the NOPs in the initially programmed section 206 of the OTP memory 204 can be then programmed to an active instruction, such as a branch, call or jump instruction. The active instruction can serve to alter the code execution by the processor 202. The active instruction can jump or branch to other parts of the initial code in the initially programmed section 206, or can jump or branch to new code (e.g., subroutine or function) that has been stored in the initially un-programmed section 208 of the OTP memory 204 which was initially left empty. This operation can be repeated or continued so long as NOPs are available to be programmed (or reprogrammed).

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, OTP memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An integrated circuit, comprising:
a processor;
a One-Time-Programmable (OTP) memory as a part or all of a memory operatively coupled to the processor; and
an instruction code for the processor, the instruction code being programmed into the OTP memory, and the instruction code having a plural of modules and at least one of the modules having at least one No-Operation (NOP) instruction,
wherein the at least one module having at least one NOP instruction being configured to be updated by programming a new module into an unused portion of the OTP memory and by programming a module-calling or branch instruction into the at least one NOP instruction to jump to a starting address of the new module or to a new target address upon execution.

2. An integrated circuit as recited in claim 1, wherein the instruction code for NOP in the processor is an instruction word of virgin states in the OTP memory.

3. An integrated circuit as recited in claim 1, wherein the at least one module having the at least one NOP instruction includes n NOPs so that the instruction code within the module is able to be re-programmed up to n times.

4. An integrated circuit as recited in claim 3, wherein the at least one module can be updated n times by repetitively programming a different module-calling or branch instruction into one of the n NOPs, starting with the last NOP to be executed in set of n consecutive NOP instructions.

5. An integrated circuit as recited in claim 1, wherein the new module contains at least one NOP instruction.

6. An integrated circuit as recited in claim 1, wherein the at least one module includes a group of instructions, a subroutine, or a function.

7. An integrated circuit as recited in claim 1, wherein the at least one module is within another module.

8. An electronics system comprising:
a processor;
a One-Time-Programmable (OTP) memory as a part or all of a code memory operatively coupled to the processor; and
an instruction code for the processor, the instruction code being programmed into the OTP memory, and the instruction code having a plural of modules and at least one of the modules having at least one No-Operation (NOP) instruction,
wherein the at least one module having at least one NOP instruction being configured to be updated by programming a new module into an unused portion of the OTP memory and by programming a module-calling or branch instruction into the at least one NOP instruction to jump to a starting address of the new module or to a new target address upon execution.

9. An electronics system as recited in claim 8, wherein the instruction code for NOP in the processor is an instruction word of virgin states in the OTP.

10. An electronics system as recited in claim 8, wherein the module is inserted with n NOPs so that the NOP space can be re-programmed n times to modify some codes n times.

11. An electronics system as recited in claim 10, wherein the module can be updated n times by repetitively programming a call-to-new module or branch instruction into a NOP, starting with the last NOP executed in n consecutive NOP instructions.

12. An electronics system as recited in claim 8, wherein the new module contains at least one NOP instruction.

13. An electronics system as recited in claim 8, wherein the module is a group of instructions, subroutine, or function.

14. An electronics system as recited in claim 8, wherein the module is within another module.

15. A method of providing an OTP memory configured to be updateable, the method comprising:
storing instruction code into the OTP memory, the instruction code to be executed by a processor operatively connect to the OTP memory, the instruction code having a plural of modules, and at least one of the modules having at least one No-Operation (NOP) instruction at a NOP location;
subsequently programming a new module into a previously unused portion of the OTP memory to stored additional instruction code to the OTP memory; and
programming a module-calling or branch instruction into the NOP location to subsequently direct program execution to the additional instruction code of the new module.

16. A method as recited in claim 15, wherein a branch or jump instruction is programmed at the NOP location to branch to a starting address of the new module.

17. A method as recited in claim 15, wherein a module call instruction is programmed at the NOP location to branch to a starting address of the new module.

18. A method as recited in claim 15, wherein the new module includes a group of instructions, a subroutine or a function.

19. A method as recited in claim 15, wherein the new module is within another module.

20. A non-transitory computer readable medium including at least computer program code stored thereon for programming an OTP memory configured to be updateable, the computer readable medium comprising:
computer program code for storing instruction code into the OTP memory, the instruction code stored being to be executable by a processor operatively connect to the OTP memory, the instruction code having a plural of modules, and at least one of the modules having at least one No-Operation (NOP) instruction at a NOP location;
computer program code for subsequently programming a new module into a previously unused portion of the OTP memory to stored additional instruction code to the OTP memory; and
computer program code for programming an instruction into the NOP location to subsequently redirect program execution to the additional instruction code of the new module.
